(19) United States
(12) Patent Application Publication
(10) Pub. No.: US 2010/0308220 A1
(43) Pub. Date: Dec. 9, 2010

(54) INSPECTION STRUCTURE AND METHOD FOR IN-LINE MONITORING WAFER

(75) Inventors: Ling-Chun Chou, Yunlin County (TW); Ming-Tsung Chen, Hsinchu County (TW); Po-Chao Tsao, Taipei County (TW); Hsi-Hua Liu, Taipei City (TW); Shuen-Cheng Lei, Taipei County (TW); Ming-Yi Lin, Keelung City (TW)

Correspondence Address: LanWay IPR Services, P.O. Box 220746, Chantilly, VA, 20153, US

(73) Assignee: United Microlelectronics Corp, Hsinchu (TW)

(21) Appl. No.: 12/480,117

(22) Filed: Jun. 8, 2009

(51) Int. Cl. G01N 23/00

(52) U.S. Cl. 250/310

(57) ABSTRACT

The method for in-line monitoring a wafer is described as follows. A wafer is provided, and at least one inspection structure is then formed on the wafer in the following steps. An N-well region and a P-well region are formed in the wafer, wherein the N-well region and the P-well region are separated from each other. A gate on each of the N-well region and the P-well region is formed. A P-type doped region is respectively formed in the N-well region and in the P-well region at both sides of the gates. A first contact plug is formed on each P-type doped region, and second contact plug is formed on each gate. Afterwards, a defect inspection is conducted utilizing an electron beam inspection (EBI) system, such that a short between each first contact plug and each gate is determined.

### BACKGROUND OF THE INVENTION

1. Field of the Invention

The present invention generally relates to an inspection structure and a method for in-line monitoring a wafer, and in particular, to an inspection structure and a method for in-line monitoring a wafer which can be applied to an electron beam inspection (EBI) system.

2. Description of Related Art

Along with the rapid progress in techniques of the semiconductor process, further improvement in integration of circuits and devices is demanded. As the circuits and the devices are continuously miniaturized, each extremely small defect arising in the fabrication becomes a significant factor which may make a great impact on overall quality of the products. Devices nowadays are designed in extremely compact form, and therefore the space between a contact window of a doped region and a word line gate reduces much. It is likely to induce a short circuit between the contact plug on the doped region and ploy silicon of the gate due to the deviation in the forming position of the contact window, if errors or mistakes occur in the fabricating process, such as mis-alignment in the lithohraphy process. Recently, defect inspection for detecting manufacturing defects has become a part of the standard procedure. Electron beam inspection (EBI) system is one of the detection systems for detecting circuit situations of the devices.

FIG. 1 schematically illustrates a top view of a conventional NMOS device inspected by the EBI system. In general, in the image demonstrated by the EBI system, the contact plug on a P-type doped region shows in a bright spot, but in a dark spot on an N-type doped region. It is feasible to recognize the short circuit between the contact plug on the doped region and the poly gate in the PMOS. Nevertheless, in the NMOS as shown in FIG. 1, the contact plugs 108 and 108′ disposed on the N-type doped region 104 and the contact plugs 106 disposed on the gates 102 show both in dark spots. The contact plug 108′ is still presented in dark even if the short circuit exists due to the contact plug 108′ touching the gate 102. Hence, the short circuit between the contact plug 108 and the poly silicon gate 102 cannot be recognized by the EBI system.

### SUMMARY OF THE INVENTION

Accordingly, the present invention is directed to a method for in-line monitoring a wafer utilizing the EBI system to conduct a real-time inspection, so as to detect circuit defects in the devices.

The present invention is also directed to an inspection structure, fabrication of which can be incorporated in the current device process.

The method for in-line monitoring a wafer of the present invention is described as follows. A wafer is provided, and at least one inspection structure is then formed on the wafer in the following steps. An N-well region and a P-well region are formed in the wafer, wherein the N-well region and the P-well region are separated from each other. A gate on each of the N-well region and the P-well region is formed. A P-type doped region is respectively formed in the N-well region and in the P-well region at both sides of the gates. A first contact plug is formed on each P-type doped region, and second contact plug is formed on each gate. Afterwards, a defect inspection is conducted utilizing an electron beam inspection (EBI) system, such that a short between each first contact plug and each gate is determined.

According to an embodiment of the present invention, the method further includes forming at least one device structure on the wafer. The inspection structure and the device structure may be formed simultaneously. The device structure includes a complementary metal oxide semiconductor (CMOS), for example.

According to an embodiment of the present invention, the inspection structure is formed on a scribe line of the wafer, e.g. the scribe line between two adjacent shots or the scribe line between two adjacent dies.

According to an embodiment of the present invention, the inspection structure is formed on a testkey at a corner of a shot.

According to an embodiment of the present invention, the inspection structure is formed within a shot of the wafer.

According to an embodiment of the present invention, the inspection structure is formed within a die of the wafer.

According to an embodiment of the present invention, the wafer only includes the inspection structure.

According to an embodiment of the present invention, the short between the first contact plug and the gate may occur when the second contact plug is a bright contact during the defect inspection conducted by the EBI system.

The inspection structure of the present invention is disposed within a wafer for being inspected by the EBI system. The inspection structure includes a first area and a second area separated from each other. The first area includes a P-well region, a gate, a P-type doped region, and contact plugs. The P-well region is configured in the wafer. The gate is disposed on the P-well region. The P-type doped region is configured in the P-well region at both sides of the gate. The contact plug is disposed on the gate, and the contact plug is disposed on the P-type region. The second area includes a N-well region, a gate, a P-type doped region, and contact plugs. The N-well region is configured in the wafer. The gate is disposed on the N-well region. The P-type doped region is configured in the N-well region at both sides of the gate. The contact plug is disposed on the gate, and the contact plug is disposed on the P-type region.

According to an embodiment of the present invention, the pattern density of the first area is greater than that of the second area.

According to an embodiment of the present invention, the inspection structure is disposed on a scribe line of the wafer, such as the scribe line between two adjacent shots or the scribe line between two adjacent dies.

According to an embodiment of the present invention, the inspection structure is disposed on a testkey at a corner of a shot.

According to an embodiment of the present invention, the inspection structure is disposed within a shot of the wafer.

According to an embodiment of the present invention, the inspection structure is disposed within a die of the wafer.

According to an embodiment of the present invention, the wafer only includes the inspection structure.

As mentioned above, the defect inspection is conducted by EBI system after forming the contact plugs of the inspection structure in the method for in-line monitoring the wafer of the present invention, so as to perform a real-time inspection in-line without taking the wafer out.

In addition, the inspection structure of the present invention includes P-type doped regions in both of the N-well region and the P-well region, and thereby the EBI system can be easily applied to the defect inspection for determine where the electrical defect arises.

In order to make the aforementioned and other features and advantages of the present invention more comprehensible, preferred embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 schematically illustrates a top view of a conventional NMOS device inspected by the EBI system.

FIG. 2 is a flow chart of a method for in-line monitoring a wafer according to an embodiment of the present invention.

FIGS. 3A-3B depict, in a cross-sectional view, a method for fabricating an inspection structure according to an embodiment of the present invention.

FIGS. 4A and 4B schematically illustrates, in a top-view, defect inspections conducted on inspection structures by using the EBI system, respectively.

FIG. 5A schematically illustrates a top view of a wafer according to an embodiment of the present invention.

FIG. 5B schematically illustrates a top view of a shot according to an embodiment of the present invention.

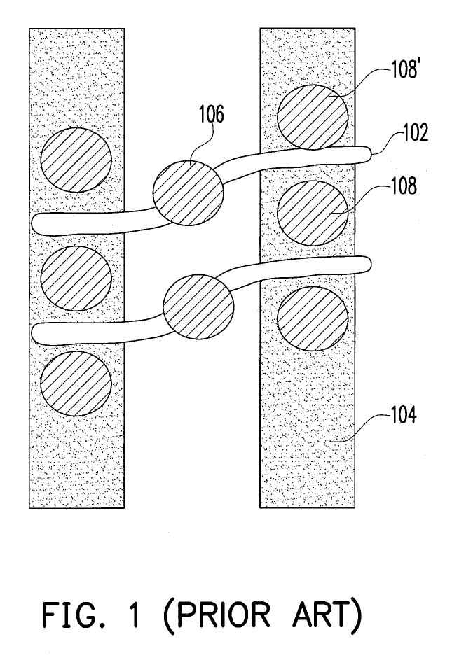

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

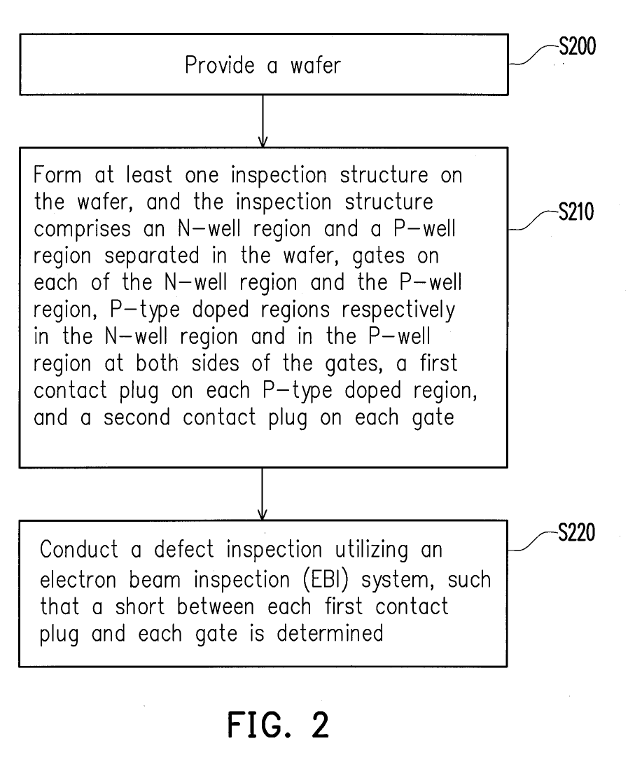

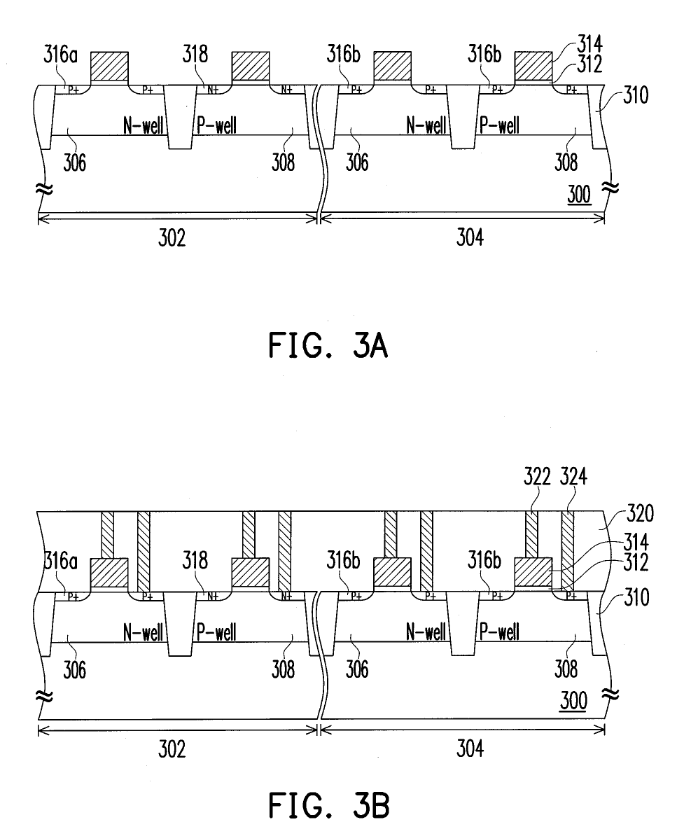

FIG. 2 is a flow chart of a method for in-line monitoring a wafer according to an embodiment of the present invention. FIGS. 3A-3B depict, in a cross-sectional view, a method for fabricating an inspection structure according to an embodiment of the present invention. The following process for fabricating the inspection structure disclosed in FIGS. 3A and 3B is provided for illustration purposes and thereby enable those of ordinary skill in the art to practice the present invention, but is not intended to limit the scope of the present invention. It is appreciated by persons skilled in the art that the forming methods and forming sequences of the components such as gate structures, doped regions, contact plugs or dielectric layers can be modified with known methods, and are not limited by the following embodiments.

Referring to FIG. 2, in step S200, a wafer is provided, which may be a semiconductor wafer, e.g. N-type silicon wafer, and P-type silicon wafer.

Next, in step S210, forming at least one inspection structure on the wafer, which is illustrated with FIGS. 3A-3B. The fabrication of the inspection structure in an embodiment of the present invention can be integrated with the CMOS device process, so as to simplify manufacturing procedures. Therefore, the process for fabricating the CMOS device and the process for fabricating the inspection structure are incorporated at the same time to illustrate the following embodiment.

Referring to FIG. 3A, a wafer 300 may include a device area 302 and an inspection area 304, wherein the inspection structure is formed within the inspection area 302. An N-well region 306 and a P-well region 308 separated from each other are formed in the wafer 300. The N-well region 306 and the P-well region 308 are separated by an isolation structure 310, for example. Thereafter, gates 314 are formed on the wafer 300 of the N-well region 306 and P-well region 308, respectively. The material of the gates 314 can be doped polycrystalline silicon. In an embodiment, a gate dielectric layer 312 may be formed between each gate 314 and the surface of the wafer 300. Afterwards, P-type doped regions 316a and 316b and N-type doped region 318 are formed in the wafer 300 at both sides of each gate 314. More specifically, the P-type doped region 316a is formed in the N-well region 306 at both sides of the gate 314 within the device area 302, and the N-type doped region 318 is formed in the P-well region 308 at both sides of the gate 314 within the device area 302. The P-type doped regions 316b are formed in the N-well region 306 and in the P-well region 308 at both sides of the gates 314 within the inspection area 304. In an embodiment, the P-type doped region 316a within the device area 302 and the P-type doped regions 316b within the inspection area 304 may be formed in the same process. The P-type doped regions 316a and 316b are P+ doped regions, and the N-type doped regions 318 are N+ doped regions, for example.

Referring to FIG. 3B, a dielectric layer 320 and contact plugs 322 and 324 are formed on the wafer 300, wherein the contact plugs 322 and 324 are disposed in the dielectric layer 320. The contact plugs 322 are deployed on the gate 312, and the contact plugs 324 are deployed on the P-type doped regions 316a and 316b and N-type doped region 318, for example. The material of the contact plugs 322 and 324 is tungsten, for example.

In the device area 302, the gate dielectric layer 312, the gate 314 and the P-type doped region 316a within the N-well region 306 serve as a PMOS, and the gate dielectric layer 312, the gate 314 and the N-type doped region 318 within the P-well region 308 serve as a NMOS, thereby constituting a CMOS device. In the inspection area 304, the N-well region 306, the P-well region 308, dielectric layers 312, the gates 314, the P-type doped regions 316b, the contact plugs 324 disposed on the P-type doped regions 316b, and the contact plugs 322 disposed on the gates 314 collectively serve as an inspection structure, for example. In an embodiment, the layout of the inspection area 304 may be identical with that of the device area 302, but the P-type doped region is substituted for the N-typed doped region in the inspection area 302. That is to say, the doped regions in the inspection area 302 are all P-type rather than N-type, so as to be applied to the EBI system in the subsequent procedure. Accordingly, defects in the device region 302 can be detected correspondingly by conducting the subsequent defect inspection to the inspection area 304.

Referring to FIG. 2 again, in step S220, a defect inspection is conducted utilizing the EBI system, such that a short circuit between the contact plug on the P-type doped region and the gate can be recognized by observing the contact plug on the gate. The EBI system scans the wafer by the electron beam to obtain signals, and analyses these signals so as to sort the circuit defects. In a detailed explanation, while the incident electron beam with low energy bombs on a target, secondary electrons, backscattering electrons and transmitted electrons are excited from the target, which are then collected to develop images by image processing system. The defects inspection is based on the distribution of bright spots and dark spots, in which the brighter spot represents the more secondary electrons collected from this position.

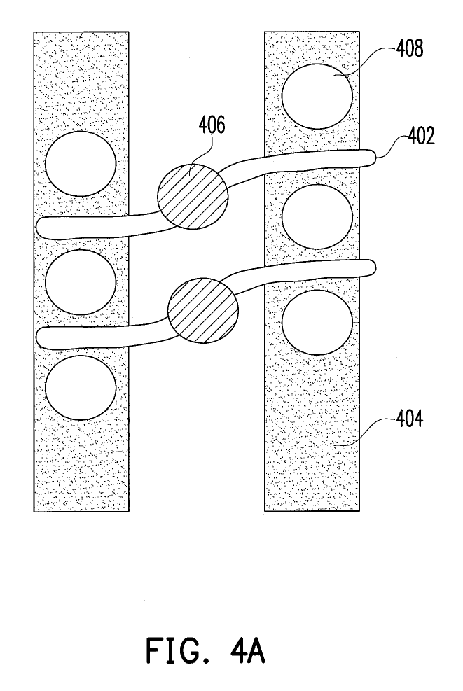

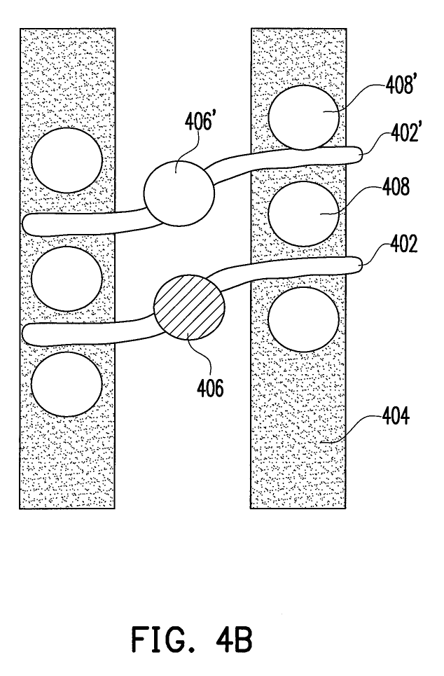

FIGS. 4A and 4B schematically illustrates, in a top-view, defect inspections conducted on inspection structures by using the EBI system, respectively. The identical elements shown in FIGS. 4A and 4B are designated with the same reference numbers, and detailed descriptions of the same or like elements are omitted hereinafter.

The following defect inspection is conducted to the inspection structure shown in FIG. 3B as an exemplary embodiment. As shown in FIG. 4A, inspection area includes gates 402 as the word line, P-type doped regions 404, contact plugs 406 disposed on the gates 402, and contact plugs 408 disposed on the P-type doped regions 404. If there is no defect, e.g. short circuit, the EBI system shows bright spots at the contact plugs 408 on the P-type doped regions 404 while the EBI system shows dark spots at contact plugs 406 on the polycrystalline silicon gates 402. The image with contrast can be obtained consequently.

Nevertheless, as illustrated in FIG. 4B, when process errors or mistakes, such like mis-alignment, arise, a short circuit between the contact plug 408′ on the P-type doped region 404 and the gate 402′ is induced. A bright spot is shown at the position of the contact plug 406′ on the gate 402′ due to the electrical conduction of the gate 402′. In other words, it can be feasible to determine whether the short occurs between the contact plugs 408 and 408′ and the gates 402 and 402′ by observing the bright or dark spots at the contact plugs 406 and 406′ on the gates 402 and 402′.

For detail explanation, when the contact plug above the gate shows in bright by the EBI system, it probably means that a short circuit arises between the gate and a contact plug on a doped region along the same word line. The inspection structure is formed with the P-type doped regions both in the P-well region and in the N-well region. Consequently, this inspection structure can be applied to correspondingly inspect the device area for defects occurred in the PMOS of the N-well region and in the NMOS of the P-well region.

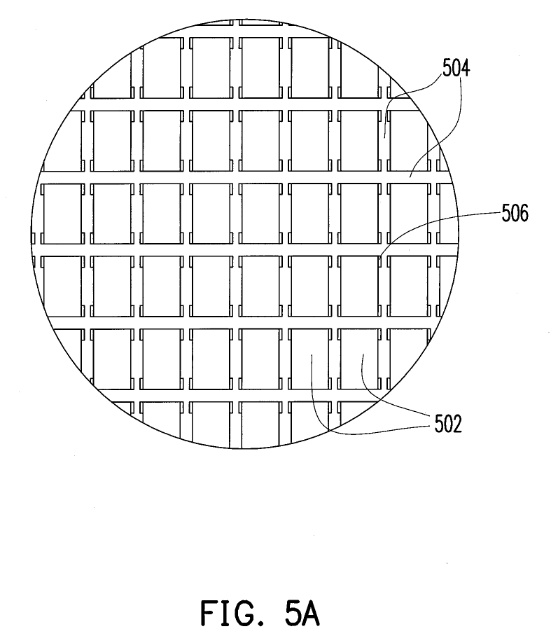

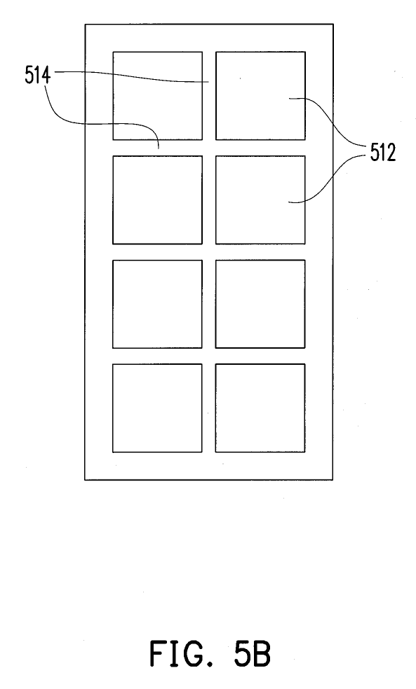

FIG. 5A schematically illustrates a top view of a wafer according to an embodiment of the present invention. FIG. 5B schematically illustrates a top view of a shot according to an embodiment of the present invention.

In an embodiment, the foregoing inspection structure can be deployed on a scribe line of the wafer, such as the scribe line 504 between two adjacent shots 502 (as shown in FIG. 5A) or the scribe line 514 between two adjacent dies 512 (as shown in FIG. 5B). In another embodiment, the inspection structure can be deployed on testkeys 506 at four corners of each shot 502 (as shown in FIG. 5A). In still another embodiment, the inspection structure can be deployed in a dummy pattern region of the wafer, such as the dummy pattern region for chemical mechanical polishing (CMP).

Besides, in an embodiment, the inspection structure can also be deployed within a shot or a die of the wafer. In other words, the whole domain within at least one shot 502 of the wafer (as shown in FIG. 5A) or within at least one die of the wafer (as shown in FIG. 5B) serves as the inspection area, while the other shots 502 (as shown in FIG. 5A) or the other dies 512 (as shown in FIG. 5B) serve as the device area so as to form the common semiconductor devices. It is noticed that the inspection area can be deployed in different positions of each wafer in the same lot, so that the position of the defects of a lot can be detected by comparing the inspection areas of the different wafers mutually in the same lot. If the defect is detected at the inspection structure in a certain shot or in a certain die of the wafer, this defect inspection parameter can be applied to the other wafers in the same lot. That is, the defect may also be detected in the corresponding shots or dies of the other wafers in the same lot.

Certainly, in other embodiments, the wafer can include only the inspection structure without any other device structure, such that this wafer can serve as an inspection wafer. Therefore, each lot of the wafers can includes at least one inspection wafer, so as to detect the defects in any position of the wafer thoroughly.

Since the real-time defect inspection utilizing the EBI system is conducted in-line after the formation of the contact plugs, the short circuit between the contact plug disposed on the doped region and the gate can be determined without taking the wafer out for conducting further failure analyses.

The inspection structure according to the present invention is then illustrated with a cross-sectional diagram of the inspection area 304 shown in FIG. 3B.

Referring to FIG. 3B, the inspection structure in the present invention is disposed within a wafer 300 for being inspected by the EBI system. The inspection structure includes a first area and a second area, wherein the pattern density of the first area may be greater than that of the second area.

The first area includes a P-well region 308, a gate 314, a P-type doped region 316b, and contact plugs 322 and 324. The P-well region 308 is configured in the wafer 300. The gate 314 is disposed on the P-well region 308. The P-type doped region 316b is configured in the P-well region 308 at both sides of the gate 314. The contact plug 322 is disposed on the gate 314, and the contact plug 324 is disposed on the P-type region 316b.

The second area includes a N-well region 318, a gate 314, a P-type doped region 316b, and contact plugs 322 and 324. The N-well region 318 is configured in the wafer 300. The gate 314 is disposed on the N-well region 318. The P-type doped region 316b is configured in the N-well region 318 at both sides of the gate 314. The contact plug 322 is disposed on the gate 314, and the contact plug 324 is disposed on the P-type region 316b.

In an embodiment, the inspection structure can be disposed on a scribe line of the wafer, such as the scribe line between two adjacent shots or the scribe line between two adjacent dies. In another embodiment, the inspection structure can be disposed on testkeys at four corners of each shot. In still another embodiment, the inspection structure can be disposed in a dummy pattern region of the wafer, such as the dummy pattern region for CMP.

Moreover, in an embodiment, the inspection structure can also be deployed within a shot or a die of the wafer. The structure deployed within at least one shot of the wafer or within at least one die of the wafer serves as the inspection structure, while the structures of the common semiconductor devices are deployed within the other shots or the other dies. In other embodiments, the wafer can include only the inspection structure without any other device structure, such that this wafer can serve as an inspection wafer.

In a layout design of static random access memory (SRAM), the current design of the SRAM includes the NMOS structure and the PMOS structure. The layout of the NMOS with the greater pattern density, for example, serves as the first area. The layout of the PMOS with the smaller pattern density, for example, serves as the second area. Since the N-type doped region in the conventional NMOS structure is replaced by the P-type doped region, the EBI system can be utilized for inspection so as to determine the physical location of the electrical defect in the devices. For illustration purposes, the foregoing is described in terms of SRAM layout and thereby enables those of ordinary skill in the art to practice the present invention, which is illustrated only as an exemplary example and should not be adopted for limiting the scope of the present invention.

In view of the above, the method for in-line monitoring the wafer of the present invention conducts the defect inspection by the EBI system after the formation of the contact plugs, so as to determine the short circuit which takes place between the gate and the contact plug on the doped region. Thus, the wafer can be inspected in-line for real-time defect analyses, without taking the wafer out for additional defect inspections.

Moreover, the inspection structure of the present invention includes P-type doped regions in both of the N-well region and the P-well region, which facilitates the EBI system for monitoring the electrical defects arising during the device process.

Further, the inspection structure and the method for in-line monitoring the wafer in the present invention can be applicable to all semiconductor devices and fabricating process thereof. The method for in-line monitoring the wafer can also easily be integrated with the current device process to form the inspection structure simultaneously. Hence, not only the process is simplified, but the process cost can be more effectively reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for in-line monitoring a wafer, comprising:
providing a wafer;
forming at least one inspection structure on the wafer, comprising:
forming an N-well region and a P-well region in the wafer, wherein the N-well region and the P-well region are separated from each other;
forming a gate on each of the N-well region and the P-well region,
forming a P-type doped region respectively in the N-well region and in the P-well region at both sides of the gates; and
forming a first contact plug on each P-type doped region, and forming a second contact plug on each gate; and
conducting a defect inspection utilizing an electron beam inspection (EBI) system, such that a short between each first contact plug and each gate is determined.

2. The method according to claim 1, further comprising forming at least one device structure on the wafer.

3. The method according to claim 2, wherein the inspection structure and the device structure are formed simultaneously.

4. The method according to claim 2, wherein the device structure comprises a complementary metal oxide semiconductor (CMOS).

5. The method according to claim 1, wherein the inspection structure is formed on a scribe line of the wafer.

6. The method according to claim 5, wherein the inspection structure is formed on the scribe line between two adjacent shots.

7. The method according to claim 5, wherein the inspection structure is formed on the scribe line between two adjacent dies.

8. The method according to claim 1, wherein the inspection structure is formed on a testkey at a corner of a shot.

9. The method according to claim 1, wherein the inspection structure is formed within a shot of the wafer.

10. The method according to claim 1, wherein the inspection structure is formed within a die of the wafer.

11. The method according to claim 1, wherein the wafer only comprises the inspection structure.

12. The method according to claim 1, wherein the short between the first contact plug and the gate occurs when the second contact plug is a bright contact during the defect inspection conducted by the EBI system.

13. An inspection structure disposed within a wafer for being inspected by an EBI system, comprising:
a first area, comprising:
a P-well region, configured in the wafer;
a first gate, disposed on the P-well region;
a first P-type doped region, configured in the P-well region at both sides of the first gate; and
two first contact plugs, respectively disposed on the first P-type region and on the first gate; and
a second area, separated from the first area and comprising:
an N-well region, configured in the wafer;
a second gate, disposed on the N-well region;
a second P-type doped region, configured in the N-well region at both sides of the second gate; and
two second contact plugs, respectively disposed on the second P-type doped region and on the second gate

14. The inspection structure according to claim 13, wherein a pattern density of the first area is greater than a pattern density of the second area.

15. The inspection structure according to claim 13, wherein the inspection structure is disposed on a scribe line of the wafer.

16. The inspection structure according to claim 15, wherein the inspection structure is disposed on the scribe line between two adjacent shots or disposed on the scribe line between two adjacent dies.

17. The inspection structure according to claim 13, wherein the inspection structure is disposed on a testkey at a corner of a shot.

18. The inspection structure according to claim 13, wherein the inspection structure is disposed within a shot of the wafer.

19. The inspection structure according to claim 13, wherein the inspection structure is disposed within a die of the wafer.

20. The inspection structure according to claim 13, wherein the wafer only comprises the inspection structure.
